(19) United States
(12) Patent Application Publication
(10) Pub. No.: US 2024/0344842 A1
(43) Pub. Date: Oct. 17, 2024

(54) METHOD OF PROVIDING SERVICE RELATED TO STOCKING AND RELEASING, AND STOCKING AND RELEASING ROUTE RECOMMENDING SYSTEM

(71) Applicants: Hyundai Motor Company, Seoul (KR); Kia Corporation, Seoul (KR)

(72) Inventors: Sunjoo Moon, Suwon-si (KR); Wonseok Choi, Seongnam-si (KR); Hyejun Park, Seoul (KR)

(21) Appl. No.: 18/635,539

(22) Filed: Apr. 15, 2024

(30) Foreign Application Priority Data
Apr. 14, 2023 (KR) 10-2023-0049219
Sep. 21, 2023 (KR) 10-2023-0126072

(51) Int. Cl. G01C 21/36

(52) U.S. Cl. CPC G01C 21/3676

(57) ABSTRACT

A method of providing a service related to stocking and releasing products can include receiving, from a first user terminal, a stocking service request signal including an first-set identification code for each of first-set products to be stocked and first GPS information of the first user terminal, determining, based on a first user's location derived from the first GPS information, stocked product loading zones in which the first-set products are to be loaded from among free spaces of workspace loading zones, and determining a first travel route from the first user's location through each of the stocked product loading zones.

### CROSS-REFERENCE TO RELATED APPLICATIONS

This application claims priority to and the benefit of Korean Patent Application No. 10-2023-0049219 filed in the Korean Intellectual Property Office on Apr. 14, 2023, and Korean Patent Application No. 10-2023-0126072 filed in the Korean Intellectual Property Office on Sep. 21, 2023, the entire contents of which are incorporated herein by reference.

### TECHNICAL FIELD

The present disclosure relates to a method and system of providing a service related to stocking and releasing.

### BACKGROUND

As the logistics market grows, more and more areas of logistics work are increasing, and efficient work within the distribution center is required to ensure fast delivery. The logistics market is experiencing a surge in labor demand, with a growing share of new workers in addition to full-time positions.

However, unlike experienced workers, new workers may not have a good grasp of the loading space in the distribution center, may be unfamiliar with the loading space, and may not be able to work efficiently.

In addition, efficient travel is required to release multiple products that are scattered and loaded within a distribution center on a single route, or to load multiple products into a distribution center on a single route.

### SUMMARY

The present disclosure relates to a method of providing a service related to stocking and releasing, and a stocking and releasing route recommending system.

Some embodiments of the present disclosure can provide a method for providing a service related to stocking and releasing, and a stocking and releasing route recommending system that can be capable of providing a location for stocking a plurality of products within a workspace and a route to travel for stocking, or a route to travel for releasing a plurality of products loaded in a workspace.

An example embodiment of the present disclosure can provide a method of providing a service related to stocking and releasing of a plurality of products by executing, by a processor, a program providing the service related to stocking and releasing of the plurality of products stored in a memory, and the method can include: receiving, from a user terminal, a stocking service request signal including an identification code for each of a plurality of products to be stocked and GPS information of the user terminal; determining, based on a user's location derived from the GPS information, a plurality of stocked product loading zones in which the plurality of products is to be loaded from among a plurality of free spaces of a plurality of loading zones; and determining a travel route from the user's location through each of the plurality of stocked product loading zones.

The determining of the plurality of stocked product loading zones may include determining zones of the plurality of free spaces close to the user's location as the plurality of stocked product loading zones.

The method may further include receiving a signal indicative of a product-specific loading priority for the plurality of loading zones from a manager terminal, in which the determining of the plurality of stocked product loading zones can include: checking free spaces in the plurality of loading zones according to a loading priority corresponding to a first product among the plurality of products to be stocked; and determining a loading zone corresponding to a free space close to the user's location among the checked free spaces as a loading zone for the first product.

The determining of the plurality of stocked product loading zones may include determining a first loading zone corresponding to a free space close to the user's location among free spaces of a plurality of first loading zones, in which a product corresponding to an identification code similar to the identification code has been already stocked, among the plurality of loading zones as the plurality of stocked product loading zones.

The method may further include generating a screen displaying the plurality of stocked product loading zones and the travel route and transmitting the generated screen to the user terminal.

The method may further include: receiving, from a first user terminal, a releasing service request signal including an identification code for each of a plurality of products to be released and first GPS information of the first user terminal; checking a plurality of released product loading zones by searching each of the plurality of products to be released from data indicating a state for each of the plurality of loading zones; determining, a travel route from a first location of the user derived from the first GPS information through all of the plurality of released product loading zones; and generating a screen displaying the plurality of released product loading zones and the the travel route and transmitting the screen to the user terminal.

Another example embodiment of the present disclosure can provide a stocking and releasing route recommending system including: a memory for storing a program that provides a service related to stocking and releasing for a plurality of products; and a processor for executing the program to provide the services related to stocking and releasing for a plurality of products to be stocked, in which when the processor receives, from a first user terminal, a stocking service request signal including an identification code for each of a plurality of products to be stocked and first GPS information of the first user terminal, the processor determines, based on a first location of a user derived from the first GPS information, a plurality of stocked product loading zones in which the plurality of products is to be loaded from among a plurality of free spaces of a plurality of loading zones, determines a travel route from the first location through each of the plurality of stocked product loading zones, when the processor receives, from a second user terminal, a releasing service request signal including an identification code for each of a plurality of products to be released and second GPS information of the second user terminal, the processor checks a plurality of released product loading zones by searching each of the plurality of products to be released from data indicating a state for each of the plurality of loading zones, and the processor determines a travel route from a second location of the user derived from the second GPS information through all of the plurality of released product loading zones.

The processor may determine that zones of the plurality of free spaces close to the user's location are the plurality of stocked product loading zones.

The processor may receive a signal indicative of a product-specific loading priority for the plurality of loading zones from a manager terminal, check free spaces in the plurality of loading zones according to a loading priority corresponding to a first product among the plurality of products to be stocked, and determine a loading zone corresponding to a free space close to the user's location among the checked free spaces as a loading zone for the first product.

The processor may determine a first loading zone corresponding to a free space close to the user's location among free spaces of a plurality of first loading zones, in which a product corresponding to an identification code similar to the identification code has been already stocked, among the plurality of loading zones as the plurality of stocked product loading zones.

According to an embodiment of the present disclosure, a worker's work efficiency may be increased by automatically recommending to the worker a stocking location for a plurality of products.

According to an embodiment of the present disclosure, when a manager wants to change the way to load products in a distribution center, he or she may change the way to load products gradually by utilizing specific conditions rather than changing all at once.

According to an embodiment of the present disclosure, it can be possible to increase the overall work efficiency of a distribution center through stocking recommendation.

According to an embodiment of the present disclosure, a worker's work efficiency may be increased by automatically recommending a releasing route for a worker to efficiently travel through a plurality of releasing locations for a plurality of products at the request of a manager.

According to an embodiment of the present disclosure, the location of a plurality of loading zones belonging to a workspace may be recognized on a single screen, allowing new workers with a limited understanding of the workspace to travel efficiently within the workspace.

### BRIEF DESCRIPTION OF THE DRAWINGS

FIG. 1 is a block diagram schematically illustrating a stocking and releasing route recommending system according to an example embodiment of the present disclosure.

FIG. 2 is a detailed block diagram for illustrating the processor of FIG. 1, according to an embodiment of the present disclosure.

FIG. 3 is a flowchart of a stocking location and route recommending method in a method of providing a service related to stocking and releasing using the stocking and releasing route recommending system according to an embodiment of the present disclosure.

FIG. 4 is a diagram illustrating an example of a screen that displays a location of a stocked product loading zone and a stocking route, according to an embodiment of the present disclosure.

FIG. 5 is a diagram of an example of a screen illustrating the stocking route shown in FIG. 4 in detail, according to an embodiment of the present disclosure.

FIG. 6 is a flowchart of a releasing route recommending method in the method of providing the service related to stocking and releasing using the stocking and releasing route recommending system according to an embodiment of the present disclosure.

### DETAILED DESCRIPTION OF ILLUSTRATIVE EMBODIMENTS

Hereinafter, an example embodiment disclosed the present specification will be described in detail with reference to the accompanying drawings, and same or similar items can be denoted by same reference numerals, and a repeated descriptions thereof can be omitted. Suffixes, “module” and and/or “unit” for a constituent element used for the description below can be given or mixed in consideration of only easiness of the writing of the specification, and the suffix itself does necessarily not have a discriminated meaning or role. Further, in describing the example embodiment disclosed in the present disclosure, when it is determined that detailed description relating to well-known functions or configurations may make the subject matter of the example embodiment disclosed in the present disclosure unnecessarily ambiguous, the detailed description of such can be omitted. Further, the accompanying drawings are provided for helping to easily understand example embodiments disclosed in the present specification, and the technical spirit disclosed in the present specification is not necessarily limited by the accompanying drawings, and it can be appreciated that the present disclosure includes all of the modifications, equivalent matters, and substitutes included in the spirit and the technical scope of the present disclosure.

Terms including an ordinary number, such as first and second, can be used for describing various constituent elements, but the constituent elements are not necessarily limited by such terms. Such terms can be used merely to discriminate one constituent element from another constituent element.

In the present disclosure, it can be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

A program implemented as a set of instructions embodying a control algorithm to control another configuration may be installed in a configuration for controlling another configuration under a specific control condition among configurations according to an example embodiment. The control configuration may process input data and stored data according to an installed program to generate output data. The control configuration may include a storage medium or a non-volatile memory to store a program and data.

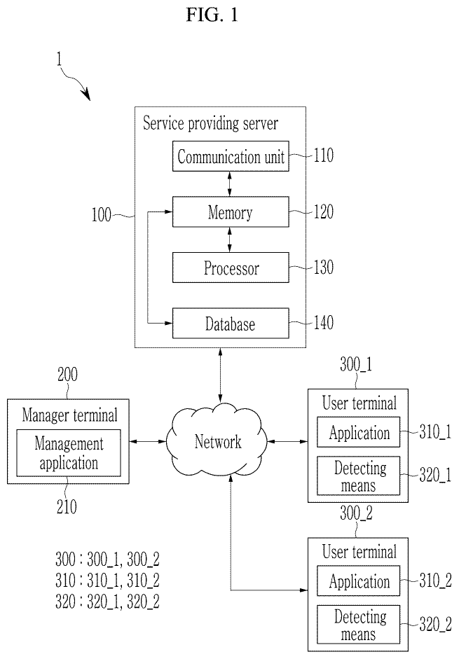

FIG. 1 is a block diagram schematically illustrating a stocking and releasing route recommending system according to an example embodiment.

Referring to FIG. 1, a stocking and releasing route recommending system 1 may include a service providing server 100, a manager terminal 200, and a plurality of user terminals 300_1 and 300_2. Each configuration can be connected to the other over a network.

A management application 210 can be installed on the manager terminal 200. A use application 310_1 can be installed on the user terminal 300_1. A use application 310_2 can be installed on the user terminal 300_2.

The user terminal 300_1 may include a detection means 320_1, and the user terminal 300_2 may include a detection means 320_2.

In the following, when describing the common operations and technical features of the plurality of user terminals 300_1 and 300_2, the plurality of user terminals 300_1 and 300_2 can be referred to as a user terminal 300. When describing the common operations and technical features of the plurality of use applications 310_1 and 310_2, the plurality of use applications 310_1 and 310_2 can be referred as use applications 310. When describing the common operations and technical features of the plurality of detecting means 320_1 and 320_2, the plurality of detecting means 320_1 and 320_2 can be referred to as a detection means 320.

In FIG. 1, the number of the plurality of user terminals 300_1 and 300_2 is shown as two, but this is for illustrative purposes only and the present disclosure is not limited thereto. The stocking and releasing route recommending system 1 may include two or more user terminals.

Hereinafter, for ease of description, the user terminal specified to describe the stocking and releasing route recommending system between the user terminals 300_1 and 300_2 will be designated as the user terminal 300_1. Also, when the terminal except for the user terminal 300_1 between the user terminals 300_1 and 300_2 will be designated as the remaining user terminal 300_2.

In the following, when describing features operating through the use application 310, the user terminal 300, the user terminal 300_1, or the remaining user terminal 300_2 is shown as operating, and when describing features operating through the management application 210, the manager terminal 200 is shown as operating.

The manager terminal 200 may be a terminal used by a manager who manages product stocking and releasing of a plurality of users and/or workspaces where products are stocked and released.

As used herein, a workspace may include a loading space for loading multiple products and a travel space for people or traveling equipment to travel within the workspace. The loading space may include a plurality of loading zones, and the plurality of loading zones may be differentiated based on the type of product, storage method, and the like.

For example, a workspace may represent a distribution center, and a loading space may represent a rack within the distribution center. The plurality of loading zones may correspond to each of the identification symbols on the rack, and the plurality of loading zones may be divided into a frozen zone, a refrigerated zone, and a room temperature zone, or may be divided into a loading zone when the product to be loaded is a food product, a loading zone when the product to be loaded is a cosmetic product, and the like, for example.

The user terminal 300 may be a terminal utilized by a user to use the stocking and releasing route recommending system and method of an embodiment of the present disclosure when the user wishes to stock products into a workspace, or when the user wishes to release products out of a workspace. A user may also be considered as a worker in that he/she performs tasks that stocks or releases items into or out of the workspace.

Each of the manager terminal 200 and the user terminal 300 may be a terminal that is capable of providing the function to transmit and receive information necessary to provide a service related to stocking and releasing a plurality of products (hereinafter, the “stocking and releasing-related service”) with the service providing server 100 over a network, and may be a terminal in which an application program that processes the received information to generate information for providing a stocking and releasing-related service is operable. For example, each of the manager terminal 200 and the user terminal 300 may be implemented as one of a smart phone, tablet PC (pad), slate PC, notebook computer, personal digital assistant (PDA), or the like, for example. The terminal applicable to each of the manager terminal 200 and the user terminal 300 is not limited to the types described above, but may be implemented as one of a variety of terminals capable of providing the functions required to provide the stocking and releasing-related service.

The user terminal 300 may be a terminal carried by the user, or may be a terminal installed in a traveling equipment (e.g., vehicle, forklift, cart) that the user is riding in.

A signal received by the manager terminal 200 from the service providing server 100 may be processed as information by an application processor (AP) of the manager terminal 200, and the AP of the manager terminal 200 may transmit the information to the management application 210 according to the example embodiment. The management application 210 may perform computations based on the information received from the AP in the manager terminal 200, and may cause the results of the performed computations to be displayed on the manager terminal 200 or transmitted to the service providing server 100 through the manager terminal 200.

The signal received by the user terminal 300 from the service providing server 100 may be processed as information by an application processor (AP) of the user terminal 300, and the AP of the user terminal 300 may transmit the information to the use application 310 according to the example embodiment. The use application 310 may perform computations based on the information received from the AP of the user terminal 300, and may cause the results of the performed computations to be displayed on the user terminal 300 or transmitted to the service providing server 100 through the user terminal 300.

The service providing server 100 may include a communication unit 110, a memory 120, a processor 130, and a database 140, any combination of or all of which may be in plural or may include plural components thereof.

The communication unit 110 may communicate with the manager terminal 200 or the user terminal 300 over a network to transmit and receive signals, data, and the like.

The memory 120 may be a storage medium that stores a program (hereinafter referred to as a “stocking and releasing route recommending program”) that provides the stocking and releasing related service to the user terminal 300 when the user wishes to stock products into the workspace or release products from the workspace. The stocking and releasing route recommending program may include a program that provides a service for recommending a location and route for stocking a plurality of products and a program that provides a service for recommending a route for releasing a plurality of products, in the stocking and releasing related service.

The processor 130 may execute the stocking and releasing route recommending program (instructions) to provide the stocking and releasing related service to the user terminal 300.

The processor 130 can be configured to process arithmetic operations, logic operations, judgment operations, and the like to provide at least one function, which may be implemented in hardware or software or a combination of hardware and software. For example, the processor 130 may be implemented in software, such as tasks, classes, subroutines, processes, objects, execution threads, and programs that are executed in a predetermined area of the memory 120, or in hardware, such as a field-programmable gate array (FPGA) or an application-specific integrated circuit (ASIC), or in a combination of the software and hardware. The processor may be included on a computer-readable storage medium, or may be distributed in parts across a plurality of computers.

The database 140 may be an on-premise, blockchain, and/or cloud data storage. The database 140 may include data representing a workspace in or from which a plurality of products is stocked or released.

The data representing the workspace may include data for each of a plurality of loading zones included in the workspace. Each of a plurality of loading zones may be matched with an x, y, and z coordinate value representing the corresponding zone. The x, y, and z coordinate value for each of the plurality of loading zones may represent the location, size, volume, and the like of the plurality of loading zones.

The database 140 may include data indicative of a state for each of the plurality of loading zones. The state of the plurality of loading zones may include, for each of the plurality of loading zones, a matched x, y, and z coordinate value, the presence or absence of free space, and the size of the free space when free space is present. As used herein, a free space may be a space among the plurality of spaces in the plurality of loading zones that are not loaded with product and are empty. The service providing server 100 can update the database 140 with the state of the plurality of loading zones that fluctuate in real time.

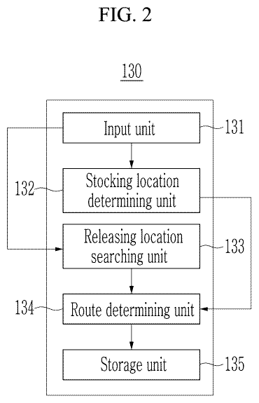

FIG. 2 is a detailed block diagram for illustrating the processor of FIG. 1.

Referring to FIG. 2, the processor 130 may include an input unit 131, a stocking location determining unit 132, a releasing location searching unit 133, a route determining unit 134, and a storage unit 135.

The input unit 131 may obtain a service request signal from the user terminal 300_1. The service request signal may include product identification information, GPS information of the user terminal 300_1, and the like. The service request signal may be either a stocking service request signal, which requests a location and route recommendation for stocking a plurality of products into the workspace, or a releasing service request signal, which requests a route for releasing a plurality of products out of the products loaded in the workspace.

The product identification information included in the stocking service request signal may include information that allows the user to check each of the plurality of products to be stocked within the workspace. In addition, the product identification information included in the releasing service request signal may include information that enables the user to check each of a plurality of products loaded in the workspace that are to be released. The product identification information may include, for each of the plurality of products to be stocked or released, the name of the product, the product code corresponding to the product, the quantity of the products when the plurality of products includes the same product, and the like.

The product identification information may correspond to the identification code of each product. The identification code may be a barcode, a QR code, a serial number, a product identification number, or other product identification information expressed in a manner that allows the product to be identified. The identification code may also include a management code, which represents management information for each product. For example, a product identification code may include a product code that can be unique to the product and a management code that indicates the expiration date of the product.

The detection means 320_1 may derive product identification information for each of the plurality of products by detecting an identification code from a zone on which the identification code can be printed for each of the plurality of products. The detecting means 320_1 may provide the product identification information to the use application 310_1.

When a user wishes to stock a product into the workspace, the detecting means 320_1 may detect product identification information for each of the plurality of products to be stocked into the workspace, and provide the detected product identification information to the use application 310_1. Alternatively, the user may input product identification information representing each of the plurality of products to be stocked into the user terminal 300_1.

The use application 310_1 may generate a stocking service request signal including product identification information and GPS information and transmit the generated stocking service request signal to the service providing server 100 through the user terminal 300_1. The stocking service request signal may be generated by the use application 310_1 when the user inputs an identification code through the user terminal 300_1 or when the user detects the identification code through the detection means 320_1. A screen for inputting an identification code on the user terminal 300_1 or for detecting the identification code through the detection means 320_1 may be generated by the use application 310_1 when the user clicks a button displayed on the user terminal 300_1 (for example, a “stocking” button).

For example, the input unit 131 may transmit a question inquiring for an identification code representing a plurality of products to be stocked within the workspace to the user terminal 300_1. When the user terminal 300_1 receives the question, the use application 310_1 may provide a screen that inquires for an identification code representing a plurality of products to be stocked within the workspace through the user terminal 300_1. When a user inputs a response to the question through the user terminal 300_1 or detects an identification code through the detecting means 320_1, the use application 310_1 may generate a stocking service request signal and transmit the stocking service request signal to the service providing server 100 through the user terminal 300_1.

Upon receiving the stocking service request signal from the user terminal 300_1, the input unit 131 may obtain product identification information from the stocking service request signal and recognize a plurality of products.

Alternatively, the manager terminal 200 may transmit a release request for the plurality of products loaded in the workspace to the user terminal 300_1 through the management application 210. The releasing request may include product identification information for each of the multiple products that need to be released. When the release request is received, the use application 310_1 may provide a screen displaying that a release is required for the plurality of products loaded within the workspace. When the user responds to the request from the manager terminal 200 through the user terminal 300_1,

The use application 310_1 may generate a release service request signal including the product identification information and GPS information through the user terminal 300_1 and transmit the generated release service request signal to the service providing server 100.

The input unit 131 may obtain the product identification information, the GPS information of the user terminal 300_1, and the like from the stocking service request signal or releasing service request signal. The input unit 131 may check a current location of the user based on the GPS information of the user terminal 300_1. The current location can refer to the location of the user terminal 300_1 at any point in time during the period from the time when the service providing server 100 receives the stocking service request signal or the releasing service request signal from the user terminal 300_1 to the time when the service providing server 100 provides the stocking and releasing related service to the user terminal 300_1.

The input unit 131 may obtain the product identification information from the stocking service request signal or the releasing service request signal, and may transmit the product identification information and a signal indicating the user's location to the stocking location determining unit 132 or the releasing location searching unit 133.

Upon receiving the stocking service request signal from the user terminal 300_1, the input unit 131 may transmit product identification information for each of the plurality of products to be stocked in the workspace (hereinafter, the “plurality of products to be stocked”) and a signal indicating the user's location to the stocking location determining unit 132.

The stocking service request signal may also include a product order input by the user for the plurality of products to be stocked. The stocking location determining unit 132 may derive a plurality of free spaces among the plurality of loading zones based on data indicative of the state of the plurality of loading zones based on the product order input by the user. For example, when a user requests the stocking service by inputting a first product and a second product into the user terminal 300_1 in order, the stocking location determining unit 132 may check a plurality of free spaces among the plurality of loading spaces for the first product, and determine a free space close to the user's location among the plurality of free spaces as a stocked product loading zone for the first product. The stocking location determining unit 132 may determine, among the remaining free spaces from the plurality of free spaces excluding the stocked product loading zone for first product, a free space close to the user's location as a stocked product loading zone for the second product,. As described above, among the plurality of loading zones, the space determined by the stocking location determining unit 132 to be a stocked product loading zone for the product may be excluded from the plurality of free spaces.

The stocking location determining unit 132 may check the plurality of products to be stocked based on the product identification information for each of the plurality of products to be stocked. The stocking location determining unit 132 may obtain data indicative of a state for each of the plurality of loading zones from the database 140 and determine a plurality of loading zones (hereinafter, “stocked product loading zones”) in the loading space to load each of the plurality of products to be stocked. In determining the stocked product loading zones, the stocked location determining unit 132 may consider data indicative of the state of each of the plurality of loading zones, the location of the user, the size/quantity of each of the plurality of products to be stocked, a product-specific loading priority for the plurality of loading zones (“loading priority”), and the like.

The stocked location determining unit 132 may derive a plurality of free spaces among the plurality of loading zones based on the data indicative of the state of the plurality of loading zones. Each of the plurality of free spaces in the plurality of loading zones may represent a space in the plurality of loading zones that is unloaded and empty.

The stocked location determining unit 132 may determine a plurality of free spaces in the plurality of loading zones that are close to the user's location as the plurality of stocked product loading zones. The stocking location determining unit 132 may check a predetermined number of free spaces in the plurality of free spaces in the plurality of loading zones in order of decreasing distance from the user's location, and in consideration of the size of the unoccupied space in each of the predetermined number of free spaces, the size of each of the plurality of products to be stocked, the quantity of the plurality of products to be stocked, and the like, determine the free spaces among the predetermined number of free spaces in which each of the plurality of products to be stocked may be stocked as the plurality of stocked product loading zones.

Alternatively, the stocking location determining unit 132 may determine a first loading zone corresponding to a free space close to the user's location among the free spaces in the plurality of first loading zones in which the product corresponding to an identification code similar to an identification code corresponding to each stocked product has been already stocked among the plurality of loading zones as the plurality of stocked product loading zones. Herein, similarity may refer to the degree of similarity between identification codes. The second identification code that is similar to the first identification code may be a code that is similar to a portion of the first identification code, or a code that represents a type that is categorized as the same type as the first identification code. Here, the type of product represented by the identification code may be pre-stored in the database 140.

For example, when the first three digits of the first identification code of a first product to be stocked are “100” categorized as a first type, and the first three digits of the second identification code of a second product to be stocked are “101” categorized as the first type, the stocking location determining unit 132 may determine the space close to the user's location in the free space of the loading zone corresponding to the zone where the second product to be stocked has been already stocked as a stocked product loading zone for the first product to be stocked.

Alternatively, the stocking location determining unit 132 may determine a stocked product loading zone for loading a plurality of products to be stocked based on the user's location, in accordance with a ranking represented by a loading priority in the free space in the loading zone that belongs within the predetermined zone.

The loading priorities may also be set differently based on the type of product, the recommended storage method for the product, the quantity of the products, the weight of the product, and the like. For example, the loading priority may include a plurality of ranking items. The plurality of ranking items may include an item that prioritizes a product stocking in zones A and B of the plurality of loading zones when the product is food, and prioritizes stocking a product in zones C and D of the plurality of loading zones when the product is cosmetics, an item that determines the location close to the user's location as the stocked product loading zone as the quantity of the product is larger, an item that varies the storage height according to the weight of the product, and loads the product on the lower floor (first or second floor) when the weight of the product is less than a predetermined reference, and loads the product on the higher floor (third floor or higher) when the weight of the product is equal to or greater than the predetermined reference, and the like. The plurality of ranking items may also include an item that directs the product to be loaded into a refrigerated or frozen loading zone of the plurality of loading zones when the product is an article that requires refrigerated or frozen storage.

The loading priorities may be pre-stored in the database 140, or may be determined based on signals received from the manager terminal 200.

Hereinafter, a method of receiving, by the service providing server 100, a loading priority from the manager terminal 200 will be described.

The manager may select a loading priority and input the selected loading priority into the manager terminal 200. For example, the stocking location determining unit 132 may transmit a question to the manager terminal 200 inquiring about loading priorities. When the manager terminal 200 receives the question, the management application 210 may provide a screen to inquire about the loading priority through the manager terminal 200. When the manager inputs a response to the question through the manager terminal 200, the management application 210 may generate a signal indicative of the loading priority and transmit the response for the loading priority to the service providing server 100 through the manager terminal 200.

Upon receiving the response for the loading priority from the manager terminal 200, the stocking location determining unit 132 may also consider the received loading priority in determining a stocked product loading zone.

Upon receiving the ranking indicative of the loading priority from the manager terminal 200, the stocking location determining unit 132 may check free spaces in the plurality of loading zones according to the loading priority corresponding to the first product to be stocked among the plurality of products to be stocked. When there is free space in the plurality of loading zones according to the loading priority, the stocking location determining unit 132 may determine that the loading zone corresponding to the free space close to the user's location among the checked free spaces is the loading zone for the first product to be stocked.

For example, a manager may input a signal to the manager terminal 200 indicating a loading priority that causes a product categorized as “snack foods” to be stocked preferentially in the zone of cell A of the plurality of loading zones. In this case, the stocking location determining unit 132 may determine the zone of free space in the zone of cell A that is close to the user's location as the stocked product loading zone for the product categorized as “snack foods” among the plurality of products to be stocked.

When there is no free space in the plurality of loading zones according to the loading priority, the stocking location determining unit 132 may determine the zones close to the user's location among the plurality of free spaces in the plurality of loading zones as the plurality of stocked product loading zones. Alternatively, when there is no free space in the plurality of loading zones according to the loading priority, the stocking location determining unit 132 may determine a loading zone corresponding to a free space close to the user's location among the free spaces in the loading zones that have been already loaded with products corresponding to identification codes similar to the identification code corresponding to each of the plurality of products to be stocked as the plurality of stocked product loading zones.

There may be multiple stocked product loading zones corresponding to each of a plurality of products to be stocked. For example, the stocking location determining unit 132 may determine a first stocked product loading zone by most preferentially considering the priority of the loading zone among the user's location, a size of each of the plurality of products to be stocked, and the priority of the loading zone, and a second stocked product loading zone most preferentially considering the distance to the loading zone from the user's location. When there are multiple stocked product loading zones corresponding to each of the plurality of products to be stocked, the route determining unit 134 may consider each of the plurality of stocked product loading zones to determine an optimal stocking route.

The stocking location determining unit 132 may generate a signal indicating the plurality of stocked product loading zones corresponding to the plurality of products to be stocked and transmit the generated signal to the route determining unit 134.

Upon receiving the signal indicating the stocked product loading zone corresponding to each of the plurality of products to be stocked from the stocking location determining unit 132, the route determining unit 134 may determine a route (hereinafter, a “stocking route”) for the user to travel to stock the plurality of products to be stocked into the workspace based on the user's current location and the location of the stocked product loading zone for each of the plurality of products to be stocked.

The stocking route may be the shortest route among the routes from the user's current location through the entire stocked product loading zones to a predetermined destination, or the route that takes the least amount of time to travel.

There may be multiple stocking routes that correspond to a single stocked product loading zone. For example, the route determining unit 134 may determine a first stocking route that is the shortest distance route among the routes that start from the user's current location and travels through all locations in the stocked product loading zone, and a second stocking route that takes the least amount of time to travel among the routes.

The route determining unit 134 may generate and transmit to the user terminal 300_1 through the communication unit 110 a screen displaying the location of each of the loading zones belonging to the stocked product loading zone and the stocking route through the stocked product loading zone.

The user terminal 300_1 may provide, through the use application 310_1, a screen displaying the location of each of the loading zones belonging to the stocked product loading zone and/or the stocking route through the stocked product loading zone.

In the case of a plurality of stocked routes, the user terminal 300_1 may provide a screen displaying the first stocking route of the plurality of stocking routes through the use application 310_1. When the user inputs a signal to the user terminal 300_1 requesting an option other than the first stocking route, the user terminal 300_1 may provide a screen displaying the second stocking route indicating the other option through the use application 310_1.

For example, when the user inputs a signal to the user terminal 300_1 to select the first stocking route between the first stocking route and the second stocking route, the user terminal 300_1 may provide a screen displaying the first stocking route through the use application 310_1.

In the case of a plurality of stocked product loading zones, the user terminal 300_1 may provide a screen displaying the first stocked product loading zone of the plurality of stocked product loading zones through the use application 310_1. When the user inputs a signal to the user terminal 300_1 requesting an option other than the first stocked product loading zone, the user terminal 300_1 may provide a screen displaying the other option, the second stocked product loading zone, through the use application 310_1.

For example, when the stocking location determining unit 132 determines the first stocked product loading zone and the second stocked product loading zone for one stocked product, and the user inputs a signal to the user terminal 300_1 to select the first stocked product loading zone among the first stocked product loading zone and the second stocked product loading zone, the user terminal 300_1 may provide a screen displaying a stocking route corresponding to the first stocked product loading zone through the use application 310_1.

Upon receiving a releasing service request signal from the user terminal 300_1, the input unit 131 may transmit product identification information for each of the plurality of products to be released among the products loaded in the workspace (hereinafter, the “plurality of products to be released”) and a signal indicating the location of the user to the releasing location searching unit 133.

The releasing location searching unit 133 may check a plurality of products to be released based on product identification information for each of the plurality of products to be released. The releasing location searching unit 133 may obtain data indicative of a state for each of the plurality of loading zones from the database 140, and search for a plurality of loading zones (hereinafter, “released product loading zones”) in the loading space where each of the plurality of products to be released is loaded.

The releasing location searching unit 133 may generate a signal indicating a plurality of released product loading zones corresponding to the plurality of products to be released and transmit the generated signal to the route determining unit 134.

The releasing service request signal may include a user-input product order of a plurality of products to be released. The releasing location searching unit 133 may search for a released product loading zone from the plurality of loading zones according to the product order input by the user. For example, when the user requests a releasing service by inputting the product order to the user terminal 300_1 in the order of the first product and the second product, the releasing location searching unit 133 may search for a released product loading zone for the first product among the plurality of loading spaces, and may search for a released product loading zone for the second product among the plurality of loading spaces.

Upon receiving a signal indicative of the plurality of released product loading zones from the releasing location searching unit 133, the route determining unit 134 may determine a route (hereinafter, the “releasing route”) for the user to travel to release the plurality of products to be released from the workspace based on the user's current location and the location of the released product loading zone for each of the plurality of products to be released.

The releasing route may be the shortest route among the routes from the user's current location to the predetermined destination through the entire released product loading zone, the route that takes the least amount of time to travel, or the like.

There may be multiple releasing routes that correspond to the released product loading zone. For example, the route determining unit 134 may determine a first releasing route that is the shortest distance route among the routes starting from the user's current location and traveling through all locations in the released product loading zone, and a second releasing route that takes the least amount of time to travel among the routes.

The route determining unit 134 may generate a screen displaying the location of each of the loading zones belonging to the released product loading zone and the releasing route through the released product loading zone and transmit the generated screen to the user terminal 300_1 through the communication unit 110.

The user terminal 300_1 may provide, through the use application 310_1, a screen displaying the location of each of the loading zones belonging to the released product loading zone and/or the releasing route through the released product loading zone.

In the case of a plurality of releasing routes, the user terminal 300_1 may provide, through the use application 310_1, a screen displaying the released product loading zone and the first releasing route of the plurality of releasing routes indicating the released product loading zone. When the user inputs a signal to the user terminal 300_1 requesting an option other than the first releasing route, the user terminal 300_1 may provide a screen displaying the other option, the second releasing route, through the use application 310_1.

When the user inputs a signal to the user terminal 300_1 to select the first releasing route between the first releasing route and the second releasing route, the user terminal 300_1 may provide a screen displaying the first releasing route through the use application 310_1.

In addition, when the route determining unit 134 is providing the stocking route or the releasing route through the user terminal 300_1, the route determining unit 134 may generate a screen displaying that the route determining unit 13 is providing the stocking route or the releasing route for the user terminal 300_1 and transmit the generated screen to the remaining user terminals 300_2 through the communication unit 110.

The remaining user terminal 300_2 may provide a screen displaying that the remaining user terminal 300_2 is providing the stocking route or the releasing route for another user through the use application 310_2.

The user may input a signal to the user terminal 300_1 indicating that the plurality of products to be stocked has been completely stocked in the stocked product loading zone. Upon receiving from the user terminal 300_1 that the plurality of products to be stocked has been completely stocked in the stocked product loading zone, the storage unit 135 may update the state of the plurality of loading zones stored in the database 140. The storage unit 135 may modify the free space in the stocked product loading zone to reflect in the database 140 that the free space has been reduced by the stocked products.

In addition, the user may input a signal to the user terminal 300_1 indicating that the plurality of products to be released has been completely released from the released product loading zone. Upon receiving from the user terminal 300_1 that the plurality of products to be released has been completely released from the released product loading zone, the storage unit 135 may update the state of the plurality of loading zones stored in the database 140. The storage unit 135 may modify the free space in the released product loading zone to reflect in the database 140 that the free space has been increased by the released products.

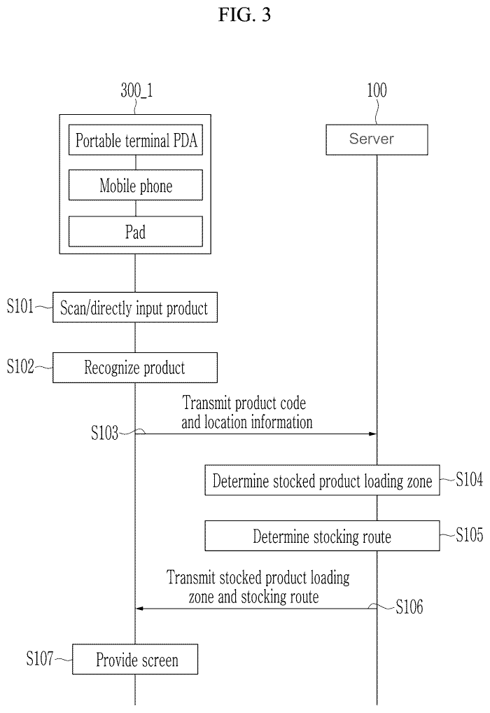

Hereinafter, a method of recommending a stocking location and route in the method of providing the service related to stocking and releasing according to the example embodiment will be described with reference to FIG. 3.

FIG. 3 is a flowchart of a stocking location and route recommending method in the method of providing the service related to stocking and releasing using the stocking and releasing route recommending system according to the example embodiment.

In the following, descriptions of the service providing server 100 and the user terminal 300_1 that are redundant with the descriptions described above may be omitted.

Referring to FIG. 3, the user terminal 300_1 may include a portable terminal (PDA), mobile phone, tablet PC (pad), or the like.

The user may scan an identification code representing a product to be stocked in a workspace, or manually input an identification code representing the product through the user terminal 300_1 (operation S101).

The use application 310_1 may recognize an identification code for each of the plurality of products scanned or input through the user terminal 300_1 (operation S102).

The use application 310_1 may transmit, through the user terminal 300_1, a stocking service request signal to the service providing server 100 that includes an identification code (product code) representing each of a plurality of products to be stocked within the workspace and GPS information of the user terminal 300_1 (operation S103).

The service providing server 100 may check each of the plurality of products to be stocked from the stocking service request signal and determine the location of the user based on GPS information included in the stocking service request signal.

The service providing server 100 may receive data indicative of a state for each of the plurality of loading zones from the database 140, and determine a stocked product loading zone by considering the data indicative of the state for each of the plurality of loading zones, the location of the user, the size of each of the plurality of products to be stocked, the priority of the loading zone, and the like (operation S104).

The priority of the loading zones may be received from the manager terminal 200 as described above.

The service providing server 100 may derive a plurality of free spaces among the plurality of loading zones based on data indicative of the state of the plurality of loading zones.

The service providing server 100 may determine zones close to the user's location in the plurality of free spaces in the plurality of loading zones as the plurality of stocked product loading zones. The service providing server 100 may check a predetermined number of free spaces in the plurality of free spaces of the plurality of loading zones in order of increasing distance from the user's location, and determine the free spaces in the predetermined number of free spaces in which each of the plurality of products to be stocked may be stocked as the plurality of stocked product loading zones by considering the size of the unoccupied space in each of the predetermined number of free spaces, the size of each of the plurality of products to be stocked, the quantity of each of the plurality of products to be stocked, and the like.

Alternatively, the service providing server 100 may determine a first loading zone corresponding to a free space close to the user's location among the free spaces in the plurality of first loading zones in which the products corresponding to an identification code similar to an identification code corresponding to each stocked product have been already stocked among the plurality of loading zones as the plurality of stocked product loading zones. The service providing server 100 may determine a zone close to the user's location among the free spaces in the zone that has been already stocked with the product corresponding to an identification code similar to the identification code of the first product to be stocked as the stocked product loading zone for the first product to be stocked.

Further, upon receiving a ranking indicative of a loading priority from the manager terminal 200, the service providing server 100 may check free spaces in the plurality of loading zones according to the loading priority corresponding to the first product to be stocked among the plurality of products to be stocked. When there is free space in the plurality of loading zones according to the loading priority, the service providing server 100 may determine that the loading zone corresponding to the free space close to the user's location among the checked free spaces is the loading zone for the first product to be stocked.

When there is no free space in the plurality of loading zones according to the loading priority, the service providing server 100 may determine the zones close to the user's location among the plurality of free spaces in the plurality of loading zones as the plurality of stocked product loading zones. Alternatively, when there is no free space in the plurality of loading zones according to the loading priority, the service providing server 100 may determine a loading zone corresponding to a free space close to the user's location among the free spaces in the loading zones that have been already loaded with products corresponding to identification codes similar to the identification code corresponding to each of the plurality of products to be stocked as the plurality of stocked product loading zones.

The service providing server 100 may determine a stocking route based on the current location of the user and the location of the stocked product loading zone for each of the plurality of products to be stocked (operation S105).

The service providing server 100 may generate a screen displaying the location of each of the loading zones belonging to the stocked product loading zone and the stocking route and transmit the generated screen to the user terminal 300_1 through the communication unit 110 (operation S106).

The user terminal 300_1 may provide, through the use application 310_1, a screen displaying the location of each of the loading zones belonging to the stocked product loading zone and/or the stocking route (operation S107).

In addition, the service providing server 100 may generate a screen displaying that the stocking route for the user terminals 300_1 are being directed to avoid overlapping travel lines between the plurality of users and transmit the generated screen to the remaining user terminals 300_2. The remaining user terminal 300_2 may provide a screen displaying that the stocking route is being directed through the use application 310_2.

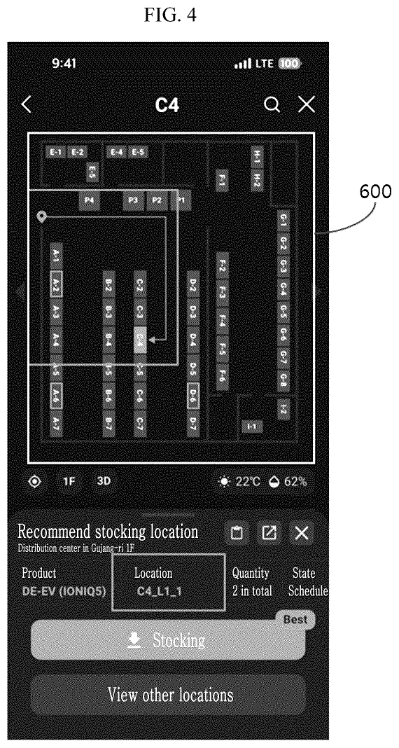

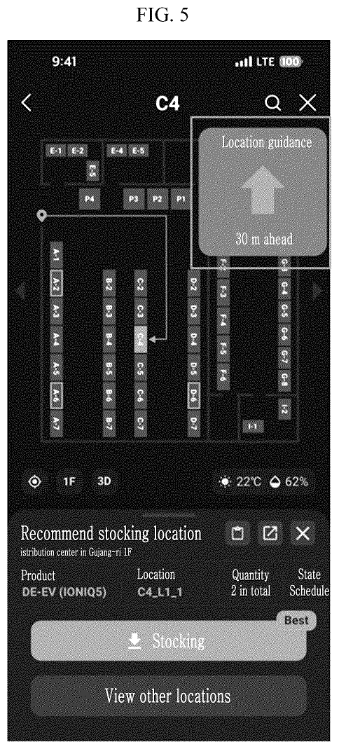

Hereinafter, a screen provided by the user terminal 300_1 will be described with reference to FIGS. 4 and 5.

FIG. 4 is a diagram illustrating an example of a screen that displays a location of a stocked product loading zone and a stocking route.

Referring to FIG. 4, the user terminal 300_1 may provide, through the use application 310_1, a screen displaying a location of a stocked product loading zone (for example, C-4) among a plurality of loading zones (A-1 to A-7, B-2 to B-7, C-2 to C-7, D-2 to D-7, E-1 to E-5, F-1 to F-6, G-1 to G-8, H-1 to H-2, and I-1 to I-2) belonging to a workspace 600 and a stocking route from the user's current location to the stocked product loading zone C-4.

The screen that displays the stocked product loading zone and the stocking route may include zones that display the name (e.g., IONIQ5) of the product to be stocked, the product code (e.g., DE-EV) corresponding to the product, the quantity (e.g., two total) of the products, and the state (e.g., to be stocked, being stocked, stocking completed, and the like).

In addition, the screen displaying the stocked product loading zone and stocking route may include a button (for example a “Stocking” button) for selecting a stocked product loading zone and/or stocking route displayed on the screen from among the plurality of stocked product loading zones and/or the plurality of stocking routes and a button (for example, a “View Other Locations” button) for requesting another option from among the plurality of stocked product loading zones and/or the plurality of stocking routes.

When a user selects the “Stocking” button and inputs the selected button into the user terminal 300_1, the user terminal 300_1 may select a stocked product loading zone displayed on the screen to provide a screen displaying a stocking route corresponding to the selected stocked product loading zone in detail through the use application 310_1.

When the user selects the “View Other Locations” button and inputs the selected button into the user terminal 300_1, the user terminal 300_1 may provide a screen displaying the location of each of the loading zones belonging to the second stocked product loading zone and the corresponding stocking route, which represent options other than the first stocked product loading zone displayed through the use application 310_1.

FIG. 5 is a diagram of an example of a screen illustrating the stocking route shown in FIG. 4 in detail.

Referring to FIG. 5, the user terminal 300_1 may add, via the use application 310_1, a screen displaying the stocking route in detail to the screen illustrated in FIG. 4 and provide the screen.

The screen displaying the stocking route in detail may include a portion indicating a direction and distance to be traveled from the user's location of the user terminal 300_1. In the example of FIG. 5, a screen displaying an upward arrow indicating straight ahead 30 meters from the user's current location and the distance traveled (30 meters) may be added to the screen in FIG. 4.

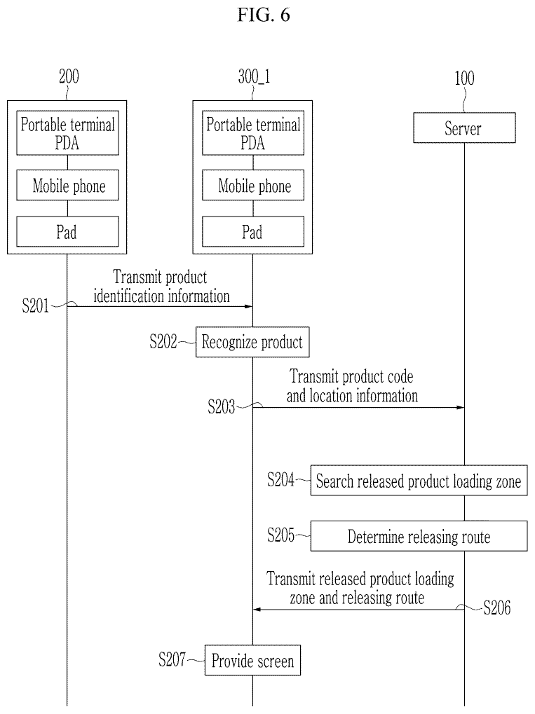

Hereinafter, a method of recommending a releasing location in the method of providing the service related to stocking and releasing according to the example embodiment will be described with reference to FIG. 6.

FIG. 6 is a flowchart of a releasing route recommending method in the method of providing the service related to stocking and releasing using the stocking and releasing route recommending system according to the example embodiment.

In the following, descriptions of the service providing server 100, the manager terminal 200, and the user terminal 300_1 that are redundant with the descriptions described above may be omitted.

Referring to FIG. 6, each of the manager terminal 200 and the user terminal 300_1 may include a portable terminal (PDA), mobile phone, tablet PC (pad), and the like, for example.

The manager terminal 200 may transmit product identification information for each of the plurality of products to be released from the workspace to the user terminal 300_1 via the management application 210 (operation S201).

The use application 310_1 may recognize an identification code for each of the plurality of products received via the user terminal 300_1 (operation S202).

The use application 310_1 may transmit, via the user terminal 300_1, a releasing service request signal including an identification code (product code) representing each of the plurality of products to be released from the workspace and GPS information of the user terminal 300_1 to the service providing server 100 (operation S203).

The service providing server 100 may check each of the plurality of products to be released from the releasing service request signal and determine the location of the user based on the GPS information included in the releasing service request signal.

The service providing server 100 may receive data indicative of a state for each of the plurality of loading zones from the database 140, and may check the loading zone of the product to be released by searching each of the plurality of products to be released from the data indicative of the state for each of the plurality of loading zones (operation S204).

The service providing server 100 may determine a releasing route based on the current location of the user and the location of the released product loading zone for each of the plurality of products to be released (operation S205).

The service providing server 100 may generate a screen displaying the location of each of the loading zones belonging to the released product loading zone and the releasing route and transmit the generated screen to the user terminal 300_1 via the communication unit 110 (operation S206).

The user terminal 300_1 may provide a screen displaying the location of each of the loading zones belonging to the released product loading zone and/or the releasing route via the use application 310_1 (operation S207).

In addition, the service providing server 100 may generate a screen displaying that the releasing route for the user terminals 300_1 are being directed to avoid overlapping travel lines between the plurality of users and transmit the generated screen to the remaining user terminals 300_2. The remaining user terminal 300_2 may provide a screen displaying that the releasing route is directed through the through the use application 310_2.

While the present disclosure has been described in connection with what is presently considered to be practical example embodiments, it can be understood that the present disclosure is not necessarily limited to the disclosed example embodiments.

What is claimed is:

1. A method comprising:
receiving, from a first user terminal, a stocking service request signal including an first-set identification code for each of first-set products to be stocked and first GPS information of the first user terminal;
determining, based on a first user's location derived from the first GPS information, stocked product loading zones in which the first-set products are to be loaded from among free spaces of workspace loading zones; and
determining a first travel route from the first user's location through each of the stocked product loading zones.

2. The method of claim 1, wherein the determining of the stocked product loading zones comprises determining a subset of free spaces that are close to the first user's location as the stocked product loading zones.

3. The method of claim 1, further comprising receiving a loading priority signal indicative of a product-specific loading priority for the workspace loading zones from a manager terminal, and
wherein the determining of the stocked product loading zones comprises:
checking the free spaces in the workspace loading zones according to a first loading priority corresponding to a first product among the first-set products to be stocked; and
determining a free loading zone corresponding to one of the free spaces that is close to the first user's location among the checked free spaces as being one of the stocked product loading zones for the first product.

4. The method of claim 1, wherein the determining of the stocked product loading zones comprises determining a first loading zone for a first product, wherein the first loading zone corresponds to one of the free spaces that is close to the first user's location among the free spaces of the workspace loading zones in which a first product type corresponding that of the first product has been already stocked, as one of the stocked product loading zones.

5. The method of claim 1, further comprising:
generating a screen displaying the stocked product loading zones and the first travel route; and
transmitting the generated screen to the first user terminal.

6. The method of claim 1, further comprising:
receiving, from a second user terminal, a releasing service request signal including a second-set identification code for each of second-set products to be released and second GPS information of the second user terminal;
checking released product loading zones by searching each of the second-set products to be released from data indicating a state for each of the workspace loading zones;
determining a second travel route from a second user's location derived from the second GPS information through the released product loading zones;
generating a screen displaying the released product loading zones and the second travel route; and
transmitting the screen to the second user terminal.

7. A stocking and releasing route recommending system comprising:
one or more processors; and
a storage medium storing computer-readable instructions, the instructions including a program that provides a service related to stocking and releasing products, that, when executed by the one or more processors, enable the one or more processors to:
receive, from a first user terminal, a stocking service request signal including a first-set identification code for each of first-set products to be stocked and first GPS information of the first user terminal,
determine, based on a first location of a first user derived from the first GPS information, stocked product loading zones in which the first-set products are to be loaded from among free spaces of workspace loading zones,
determine a first travel route from the first location through each of the stocked product loading zones,
receive, from a second user terminal, a releasing service request signal including a second-set identification code for each of second-set products to be released and second GPS information of the second user terminal,
check released product loading zones by searching each of the second-set products to be released from data indicating a state for each of the workspace loading zones, and determine a second travel route from a second location of a second user derived from the second GPS information through the released product loading zones.

8. The system of claim 7, wherein the instructions further enable the one or more processors to determine that nearby zones of the free spaces close to the first location are the stocked product loading zones.

9. The system of claim 7, wherein the instructions further enable the one or more processors to:
receive a loading priority signal indicative of a product-specific loading priority for the workspace loading zones from a manager terminal;
check the free spaces in the workspace loading zones according to a first loading priority corresponding to a first product among the first-set products to be stocked; and
determine a free loading zone corresponding to one of the free spaces being close to the first location among the checked free spaces as being one of the stocked product loading zones for the first product.

10. The system of claim 7, wherein the instructions further enable the one or more processors to determine a first loading zone for a first product, wherein the first loading zone corresponds to one of the free spaces that is close to the first location among the free spaces of the workspace loading zones in which a first product type corresponding that of the first product has been already stocked, as one of the stocked product loading zones.

11. The system of claim 7, wherein instructions further enable the one or more processors to:
generate a screen displaying the stocked product loading zones and the first travel route; and
transmit the generated screen to the first user terminal.

12. The system of claim 7, wherein instructions further enable the one or more processors to:
receive a releasing service request signal from a second user terminal, the releasing service request including a second-set identification code for each of second-set products to be released and second GPS information of the second user terminal;
check released product loading zones by searching each of the second-set products to be released from data indicating a state for each of the workspace loading zones;
determine a second travel route from a second user's location derived from the second GPS information through the released product loading zones.

13. The system of claim 12, wherein instructions further enable the one or more processors to:
generate a screen displaying the released product loading zones and the second travel route; and
transmitting the screen to the second user terminal.

14. A method of stocking and releasing a plurality of products by executing, the method comprising:
transmitting, from a user terminal, a stocking service request signal including an identification code for each of a plurality of products to be stocked and GPS information of the user terminal;
receiving, at the user terminal, a travel route from a location of user terminal through each of a plurality of stocked product loading zones in which the plurality of products is to be loaded from among a plurality of free spaces of a plurality of loading zones, the plurality of stocked product loading zones being derived based on a user's location derived from the GPS information; and
moving along the travel route; and
loading the plurality of products in the free spaces of the loading zones.

15. The method of claim 14, further comprising receiving a screen displaying the plurality of stocked product loading zones and the travel route.

16. The method of claim 14 further comprising:
transmitting, from the user terminal, a releasing service request signal including an identification code for each of a plurality of products to be released and first GPS information of the first user terminal; and
receiving a screen displaying a plurality of released product loading zones and a travel route from a current location of the user derived from the first GPS information through all of the plurality of released product loading zones.

17. The method of claim 14, wherein the plurality of stocked product loading zones includes zones determined to be close to the user's location.

18. The method of claim 14, further comprising a signal indicative of a product-specific loading priority for the plurality of loading zones.
